(19) United States
(12) Patent Application Publication
(10) Pub. No.: US 2008/0124683 A1
(43) Pub. Date: May 29, 2008

(54) Motion simulator system

(76) Inventor: Pat Gregory Medford, Phoenix, AZ (US)

Correspondence Address: MESCHKOW & GRESHAM, P.L.C., 5727 NORTH SEVENTH STREET, SUITE 409, PHOENIX, AZ, 85014, US

(21) Appl. No.: 11/526,323

(22) Filed: Sep. 25, 2006

(51) Int. Cl. G09B 9/00

(52) U.S. Cl. 434/29

(57) ABSTRACT

A motion simulator system (20) includes a base (24) and a platform (26). A first actuator (74) couples to the platform (26) at a point (138) rotatable relative to a first axis (70) and couples to a rotation part (132) of a first motor (82) at a point (140) rotatable relative to a second axis (68). A second actuator (76) couples to the platform (26) at a point (154) rotatable relative to the second axis (68) and couples to a rotation part (148) of a second motor (84) at a point (158) rotatable relative to the first axis (70). A controller (80) in communication with the first and second actuators (74, 76) via the motors (82, 84) imparts translational movement (146, 162) to the first and second actuators (74, 76) that enables motion of the platform (26) about the first and second axes (70, 68) and in heave (66).

### TECHNICAL FIELD OF THE INVENTION

The present invention relates to the field of motion simulator systems. More specifically, the present invention relates to a motion simulator system for attachment of an infant seat and imparting motion that simulates vehicular movement.

### BACKGROUND OF THE INVENTION

While in the womb, the pre-born baby resides comfortably in his free-floating environment where the temperature is constant and nutritional needs are automatically and predictably met. Birth suddenly disrupts this environment. During the months following birth, a baby tries to adapt to life outside the womb. Birth and adaptation to postnatal life bring out the temperament of the baby, so for the first time, he must do something to have his needs met. He is forced to act, to “behave” in a manner that communicates his or her needs. For example, if the baby is hungry, cold, startled, in pain, bored, over stimulated, or tired he may cry.

Some infants are termed “colicky.” Although colic is difficult to define, it is perceived as unexplained paroxysms or irritability, fussing, crying and often sustained screaming. This behavior often lasts for at least two hours, occurs at specific times of the day (often late in the evening), and happens at least three times a week. This pattern usually sets in sometime during the first month. It has been thought that the main cause of colic in infants was due to gastrointestinal problems. However, this is not always true. Pediatricians have also associated colic to temperament, environment, an immature nervous system, and a baby's inability to shut out an irritating environment. Whatever the cause, colic is harmless to the baby and typically subsides on its own by the end of the third month.

Regardless of the reasons for fussiness in infants, a distressed and crying infant can be highly frustrating and stressful for the baby's caregivers. They may be upset and worried about their baby. They can even feel resentful and angry toward the baby at times. Unfortunately, this crying can result in nursing problems, marital stress, postpartum depression, unnecessary emergency room visits, and even shaken baby syndrome.

Many calming techniques have evolved to calm crying infants. Most calming techniques involve at least one of the following interactions: rhythmic motion, soothing sounds, visual delights and distractions, close physical contact and touching. It is thought that such techniques, with the exception of visual ones, activate a baby's calming reflex during the first months of life by mimicking the experiences in the uterus. Rhythmic motion, or motion pacification, has been found to be particularly effective, and even hypnotic, in some instances.

Some prior art motion pacification systems impart vibration through the infant's bed mattress in an attempt to sooth an infant. Other motion pacification systems employ a rocking action that is intended to imitate the normal maternal head to toe rocking movement. The concept of motion pacification in babies has been studied, and it has been determined that the random or unpredictable nature of the motion may be the key to stimulating a baby's calming reflex. Consequently, prior art systems that vibrate or rock employ a repetitive motion technique that may be ineffective due to the concept of motion anticipation.

When all else fails, many parents have resorted to driving their crying infant around in the car. Whether it's the random nature of vehicular movement, the secure containment in the car seat, the change of scenery, the sound of the vehicle, or some combination thereof, much anecdotal evidence indicates that a car ride can stop the tears of a crying baby. However, taking a car ride is not always practical or safe. For example, some individuals may not have a vehicle readily at their disposal. When parents do have a vehicle at their disposal, a car ride may place the infant and caregiver in an excessively risky situation such as during a high traffic time of day, or it may be late at night when infant caregivers are already tired and less alert. Another problem with a car ride is that if the driving route has many left turns, an infant may start crying again at each stop. Yet another problem with a car ride is the costliness of the car ride due to ever increasing fuel prices.

Accordingly, what is needed is a motion pacification system that imparts random or unpredictable movement. What is further needed is a system for calming an infant that simulates vehicular movement without the known disadvantages of actual vehicular use, e.g., lack of availability, safety factors, time of day, and excessive fuel costs.

### SUMMARY OF THE INVENTION

Accordingly, it is an advantage of the present invention that a motion simulator system is provided.

It is another advantage of the present invention that a motion simulator system is provided that simulates the motion of a vehicle.

Another advantage of the present invention is that a motion simulator system is provided that is adapted for attachment of an infant seat.

Yet another advantage of the present invention is that a motion simulator system is provided that is cost effectively produced and maintained, is durable, and can provide a variety of motion profiles.

The above and other advantages of the present invention are carried out in one form by a motion simulator system that includes a base and a platform. A first actuator has a first upper end coupled to the platform at a first upper pivot point rotatable relative to a first principal axis and a first lower end in communication with the base via a first lower pivot point rotatable relative to a second principal axis that is orthogonal to the first principal axis. A second actuator has a second upper end coupled to the platform at a second upper pivot point rotatable relative to the second principal axis and a second lower end in communication with the base via a second lower pivot point rotatable relative to the first principal axis. A controller is in communication with each of the first and second actuators for imparting translational movement to the first and second movable actuators. The translational movement enables motion of the platform relative to the base about the first principal axis, about the second principal axis, and in heave.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a motion simulator system in accordance with a preferred embodiment of the present invention;

FIG. 2 shows an exploded perspective view of the motion simulator system;

FIG. 3 shows a block diagram of a control arrangement for the motion simulator system;

FIG. 4 shows a perspective view of a base of the motion simulator system;

FIG. 5 shows an illustrative view of a first motor and a first actuator of the motion simulator system;

FIG. 6 shows an illustrative view of motors and actuators housed within the base of the motion simulator system; and

FIG. 7 shows an illustrative view of a stabilizer system within the base of the motion simulator system.

### DETAILED DESCRIPTION OF THE PREFERRED EMBODIMENTS

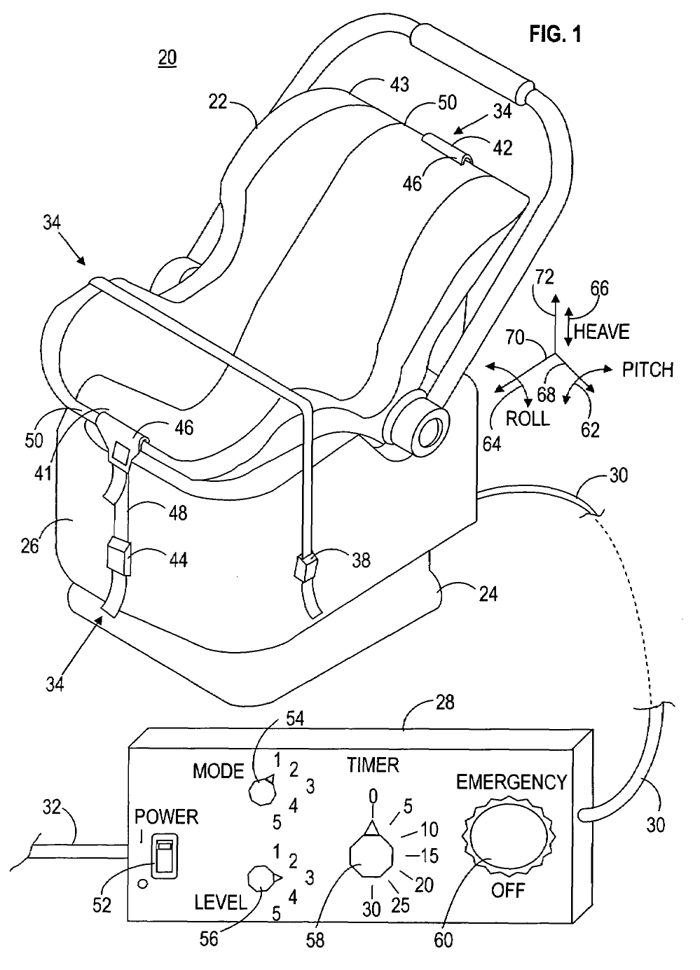

FIG. 1 shows a perspective view of a motion simulator system 20 in accordance with a preferred embodiment of the present invention. Motion simulator system 20 is adapted to enable attachment of an infant seat 22, such as an infant car seat. A typical infant car seat is designed for infants from birth until the baby weights approximately twenty pounds. Consequently, such an infant car seat is typically utilized for newborns who may be suffering from colic or are otherwise fussy.

Motion simulator system 20 is described herein in connection with its use for soothing very young infants who normally fit in an infant car seat. However, it will become readily apparent in the ensuing discussion that motion simulator system 20 need not be limited for use with infant car seats, but may instead be shaped to support a variety of infant and/or toddler seats. In addition, the present invention need not be adapted for attachment of an infant seat, but may instead be shaped to accommodate direct placement of an infant. Moreover, the present invention is not limited to its use with infants, but may be adapted for use with toddlers, children, and/or adults.

Motion simulator system 20 includes a base 24 and a platform 26 that moves relative to base 24. Movement of platform 26 is controlled by a handheld user manipulated module 28 positioned remote from base 24. Transfer means, in the form of a cable 30, couples user module 28 with internal mechanisms (discussed below) housed in base 24. Power may be provided to user module 28 and the internal mechanisms in base 24 via a power cord 32 that plugs into a conventional electric wall socket. Those skilled in the art will recognize that a wireless communication link and its associated circuitry may be utilized in lieu of cable 30. In addition, although system 20 is powered via conventional building provided electricity, system 20 may alternatively be battery powered.

Platform 26 is shaped to cradle infant seat 22 for secure placement and retention of infant seat 22. Platform 26 may be formed from a plastic material, such as polyethylene, and may be manufactured employing a rotational molding or a blow molding technique. However, those skilled in the art will recognize that other manufacturing methodologies may be employed and other materials may alternatively be selected.

Platform 26 further includes a fastener system 34 for attachment of infant seat 22 to platform 26. In one embodiment, fastener system 34 includes a strap 36 and a pair of clips 38, of which only one is visible, secured to platform 26. Strap 36 is directed across the width of infant seat and secures to each of clips 38. In addition, fastener system 34 includes a front strap 40 configured for attachment at a foot end 41 of infant seat 22 and a rear strap 42 configured for attachment at a head end 43 of infant seat 22. Each of front and rear straps 40 and 42, respectively, includes a clip 44 fastened to platform 26, a hook element 46, and a band 48 received by each of clip 44 and hook element 46. Hook element 48 grasps an edge portion 50 of infant seat 22 and band 48 can be pulled securely and tightened at clip 44 to further secure infant seat to platform 26. Fastener system 34 provides four points of connection for ensuring the secure connection of infant seat 22 to platform 26 and to accommodate various shapes and brands of infant seats. Those skilled in the art will recognize that a variety of fastener systems may be employed that function to retain infant seat 22 to platform 26.

User module 28 includes controls for enabling a user to select a variety of motion profiles, intensities, movement duration, and power control. More specifically, user module 28 includes a power switch 52, a mode control 54 for selecting one of a number of motion profiles, a level control 56 for setting the intensity or displacement of platform 26, and a timer control 58 for setting a duration during which motion of platform 26 will be enabled. User module 28 may optionally include an emergency shut-off button 60 for immediate discontinuation of motion. Those skilled in the art will recognize that user module 28 may include more or less controls, a user display, and other components for allowing a user to operate motion simulator system 20.

Motion simulator system 20 generally provides three degrees-of-freedom motion. This motion includes two rotational components, i.e., pitch 62 and roll 64, and one translational component, i.e., heave 66. Pitch 62 describes rotation about a lateral or transverse principal axis 68. Roll 64 describes rotation about a longitudinal principal axis 70, and heave 66 describes upward and downward linear movement along a vertical axis 72. Taken in combination, pitch 62, roll 64, and heave 66 generally mimic the movement of an automobile without resorting to a more complex and costly six degrees-of-freedom motion simulator.

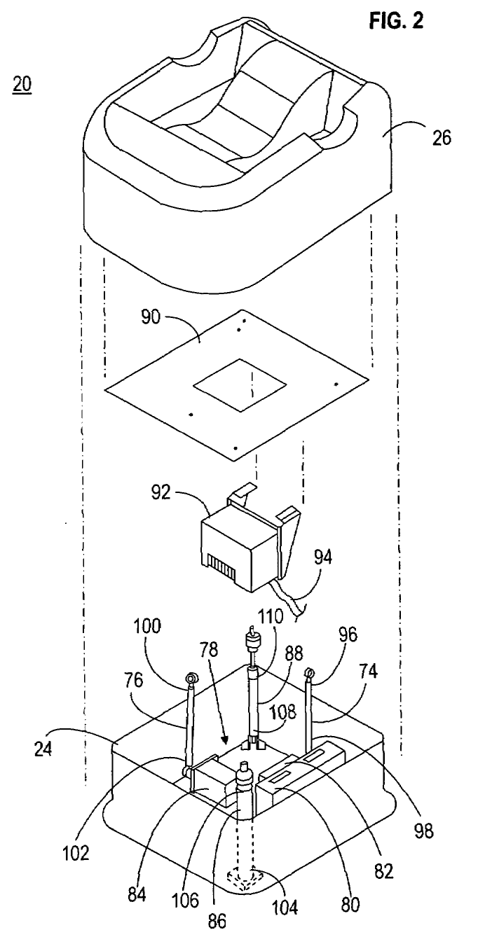

FIG. 2 shows an exploded perspective view of motion simulator system 20. Base 24 houses a first actuator 74, a second actuator 76, a motor system 78, and a controller 80. In one embodiment, motor system 78 includes a first motor 82 and a second motor 84 each of which is fastened to base 24. Base 24 further houses a fixed-length stabilizer 86 and a length-adjustable stabilizer 88. A mounting plate 90 fastens to a bottom side of platform 26 and means for detecting motion of platform 26 is fastened to an underside of mounting plate 90. In one embodiment, means for detecting motion of platform 26 may include a three-axis accelerometer used as an inclinometer 92. Communication means, in the form of a flexible cable 94, provides motion data from inclinometer 92 to controller 80.

First actuator 74 has a first upper end 96 coupled to mounting plate 90 of platform 26 and a first lower end 98 in communication with base 24 via first motor 82. Likewise, second actuator 76 has a second upper end 100 coupled to mounting plate 90 and a second lower end 102 in communication with base 24 via second motor 84. Interconnection between first actuator 74 and each of mounting plate 90 and first motor 82 is achieved at pivot points, discussed below. Interconnection between second actuator 76 and each of mounting plate 90 and second motor 84 is also achieved at pivot points, discussed below.

Fixed-length stabilizer 86 may be a fixed-length non-extendible rod element. On the other hand, length-adjustable stabilizer 88 may include a cylinder with an extensible rod, a spring, extendible links, and so forth that allow stabilizer 88 to increase and decrease in length in response to movement of platform 26.

Fixed-length stabilizer 86 has one end non-pivotally coupled to one of base 24 and platform 26 and has the opposing end pivotally coupled to the other of base 24 and platform 26. For example, fixed-length stabilizer 86 has a first end 104 non-pivotally coupled with base 24 and a second end 106 pivotally coupled with mounting plate 90 of platform 26. Length-adjustable stabilizer 88 has a third end 108 pivotally coupled with base 24 and a fourth end 110 pivotally coupled with mounting plate 90 of platform 26. The pivotal interconnections of fixed-length stabilizer 86 and length-adjustable stabilizer 88 with base 24 and mounting plate 90 are discussed below.

First motor 82 enables translational movement of first actuator 74, and second motor 84 enables translational movement of second actuator 76. Controller 80 is in communication with each of first and second motors 82 and 84, respectively, and is controlled by user module 28 (FIG. 1). Controller 80 regulates movement of first and second motors 82 and 84 to effect translational movement of first and second actuators 74 and 76, respectively.

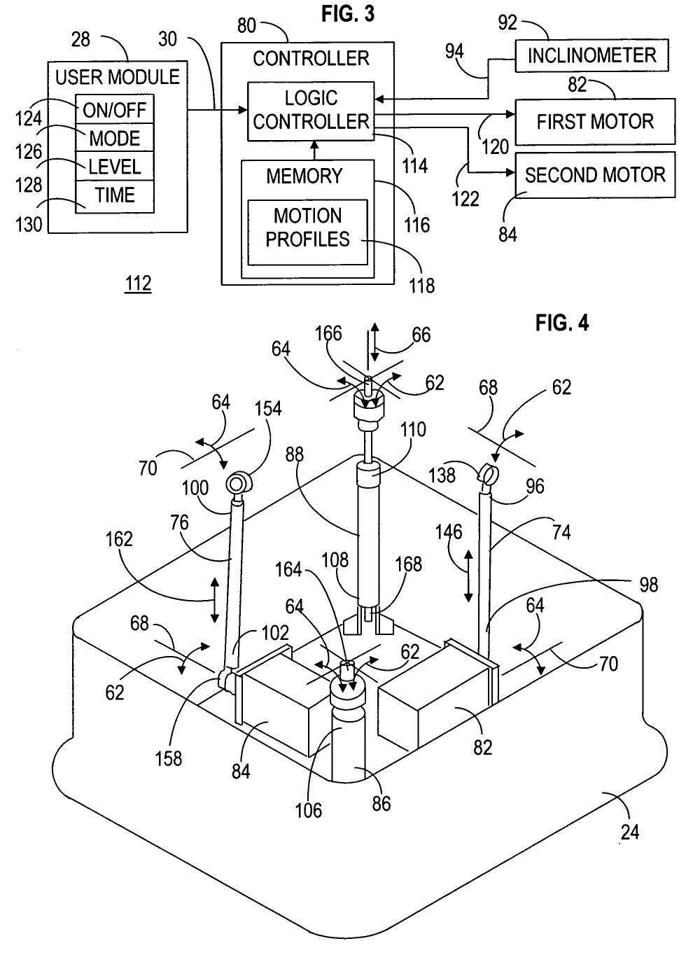

FIG. 3 shows a block diagram of a control arrangement 112 for motion simulator system 20 (FIG. 1). Control arrangement 112 includes user module 28 in communication with controller 80 via cable 30. Controller 80 includes a logic controller 114 and a memory element 116 in communication with logic controller 114. Of course, controller 80 includes other components known to those skilled in the art, such as a timer, power switching capability, and so forth, not described herein for brevity.

Memory element 116 includes a database 118 of motion profiles that are selectable via user data received from user modules 28. These motion profiles could simulate fast or slow movement along a hilly road, a curved road, a bumpy road, or some combination thereof. In order to populate database 118 with the motion profiles, a three-axis accelerometer can be mounted to an automobile to sense motion for simulation on several types of driving scenarios. This three-axis accelerometer data can then be transferred to a “look-up” table which is subsequently downloaded to memory element 116. Alternatively or additionally, accelerometer recording equipment may be installed on a free moving test platform. The free moving test platform can be moved manually with or without an infant on the test platform. The manually generated motion is then recorded, and the data can be transferred to memory element 116, such that a custom type motion can be stored and reproduced.

An output of logic controller 114 is in communication with first motor 82 via a first communication link 120, and another output of logic controller 114 is in communication with second motor 84 via a second communication link 122. Actual position data of platform 26 (FIG. 1) from inclinometer 92 is received at logic controller 114 via flexible cable 94.

In one embodiment, controller 80 receives a power signal 124, a mode signal 126, an intensity/level signal 128, and a selected duration/time signal 130 from user module 28. Mode signal 126 may include one of highway, off-road, city, winding, or random mode. Intensity/level signal 128 provides the desired subtlety of the motion, with “1” being the most subtle and “5” being the least subtle.

In response to receipt of these signals, logic controller 114 accesses one of the motion profiles from database 118 and appropriately signals first and second motors 82 and 84, respectively, to impart translational movement to first and second actuators 74 and 76, respectively (FIG. 2). For example, articulation of platform 26 can be accomplished by logic controller 114 sequentially comparing recorded angles of the actual reference motion data stored in database 118 to the real-time angle of platform 26 from inclinometer 92. This comparison allows logic controller 114 to adjust first and second actuators 74 and 76, respectively, to produce three-axis “motion simulation.” The translational movement results in the desired combination of pitch 62 (FIG. 1), roll 64 (FIG. 1), and heave 66 (FIG. 1) mimicking a desired vehicular motion.

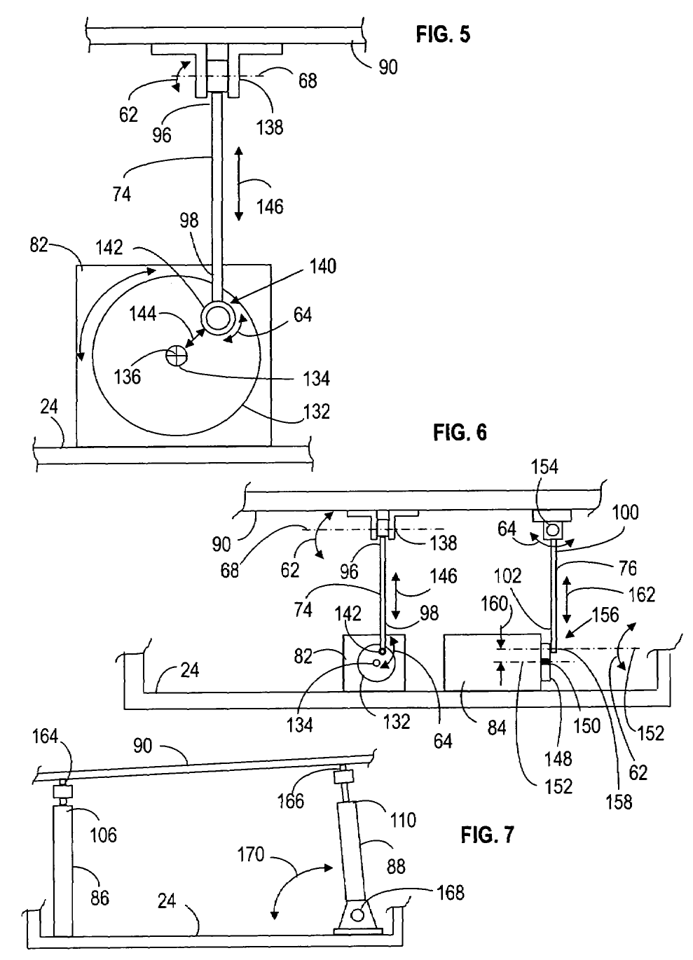

Referring to FIGS. 4-6, FIG. 4 shows a perspective view of base 24 of motion simulator system 20 (FIG. 1). Controller 80 (FIG. 2) is not shown in FIG. 4 for clarity of illustration. FIG. 5 shows an illustrative view of first motor 82 and first actuator 74 of motion simulator system 20, and FIG. 6 shows an illustrative view of an orientation of first motor 82 and first actuator 74 relative to second motor 84 and second actuator 76 within base 24 of motion simulator system 20.

A first rotation part 132 is coupled to a first shaft 134 of first motor 82. Thus, first rotation part 132 is rotatable about a first axis of rotation 136 which is substantially parallel to longitudinal axis 70 (FIG. 1) and is centered at first shaft 134 of first motor 82. First upper end 96 of first actuator 74 is coupled to mounting plate 90 at a first upper pivot point 138 that is rotatable relative to a first principal axis, in this case, transverse axis 68. First lower end 98 of first actuator 74 is coupled at a first position 140 on first rotation part 132 via a first lower pivot point 142. As such, first lower pivot point 142 is rotatable relative to a second principal axis, in this case, longitudinal axis 70 that is orthogonal to transverse axis 68.

The structure of first upper pivot point 138 enables rotation of first upper end 96 of first actuator 74 about transverse axis 68 (i.e., in pitch 62). In addition, the structure of first lower pivot point 140 enables rotation of first lower end 98 of first actuator 74 about longitudinal axis 70 (i.e., in roll 64). In a preferred embodiment of the present invention, each of first upper and first lower pivot points 138 and 140, respectively, are universal joints that permit rotation about three axes, i.e., transverse axis 68, longitudinal axis 70, and the normal axis (yaw), so that binding will not occur at either end of first actuator 74 as first actuator 74 translates. One known bearing that may be employed for these universal joints is a rod end bearing typically utilized on the ends of cylinders, linkages, rods, shafts, and the like to take up angular misalignment between connected parts. Those skilled in the art will recognize, however, that other bearings may be utilized to form the universal joints at each end of first actuator 74.

First position 140 is located a radial distance 144 away from first axis of rotation 136. First actuator 74 is a non-extendible rod element. Accordingly, when first motor 82 is actuated to rotate first rotation part 132, translational movement 146 is imparted to first actuator 74. Translational movement 146 enables motion of mounting plate 90 and platform 26 relative to base 24. First upper pivot point 138 and first lower pivot point 142 allow first actuator 74 to pivot relative to both transverse and longitudinal axes 68 and 70, respectively, to accommodate the curved path of travel of first actuator 74 due to the rotation of first rotation part 132.

A second rotation part 148 is coupled to a second shaft 150 of second motor 84. Thus, second rotation part 148 is rotatable about a second axis of rotation 152 which is substantially parallel to transverse axis 68 and is centered at second shaft 150 of second motor 84. Second upper end 100 of second actuator 76 is coupled to mounting plate 90 at a second upper pivot point 154 that is rotatable relative to a second principal axis, in this case, longitudinal axis 70. Second lower end 102 of second actuator 76 is coupled at a second position 156 on second rotation part 148 via a second lower pivot point 158. As such, second lower pivot point 158 is rotatable relative to a second principal axis, in this case, transverse axis 68. In one embodiment, second axis of rotation 152 is arranged orthogonal to first axis of rotation 136. However, such is not a limitation of the present invention. In an alternative embodiment, the orientation of first and second shafts 134 and 150, hence first and second axes rotation 136 and 152, can be arranged to best accommodate the available space within an interior of base 24.

The structure of second upper pivot point 154 enables rotation of second upper end 100 of second actuator 76 about longitudinal axis 70 (i.e., in roll 64). In addition, the structure of second lower pivot point 158 enables rotation of second lower end 102 of second actuator 76 about transverse axis 68 (i.e., in pitch 62). However, in a preferred embodiment of the present invention each of second upper and second lower pivot points 154 and 158, respectively, are universal joints that permit rotation about three axes, i.e., transverse axis 68, longitudinal axis 70, and the normal axis, so that binding will not occur at either end of second actuator 76 as second actuator 76 translates. Again, a rod end bearing may be utilized for each of the universal joints of second actuator 76.

Second position 156 is located a radial distance 160 away from second axis of rotation 152. Like first actuator 74, second actuator 76 is a non-extendible rod element. Accordingly, when second motor 84 is actuated to rotate second rotation part 148, translational movement 162 is imparted to second actuator 76. Translational movement 162 enables motion of mounting plate 90 and platform 26 relative to base 24. Second upper pivot point 154 and second lower pivot point 158 allow second actuator 74 to pivot relative to both transverse and longitudinal axes 68 and 70, respectively, to accommodate the curved path of travel of second actuator 76 due to the rotation of second rotation part 148.

Motion simulator system 20 utilizes a translation-to-rotation system to generate motion of platform 26 about transverse and longitudinal axes 68 and 70, respectively, and in heave 66. The translation-to-rotation system, including a motor, a rotation part, a non-extendible rod actuator, and interconnecting pivot points, yields system 20 that is cost effective to produce, simple in design, and durable. However, those skilled in the art will recognize in an alternative embodiment, a translation-to-rotation system might utilize motorized lift screws, hydraulic actuators, pneumatic actuators, and the like.

Referring to FIG. 7 in connection with FIG. 4, FIG. 7 shows an illustrative view of a stabilizer system, in the form of fixed-length stabilizer 86 and length-adjustable stabilizer 88, within base 24 of motion simulator system 20 (FIG. 1). Length-adjustable stabilizer 88 diagonally opposes fixed-length stabilizer 86 within base 24. That is, length-adjustable stabilizer 88 and fixed-length stabilizer 86 are positioned in opposite corners of base 24. In a preferred embodiment, fixed-length stabilizer 86 is positioned in base 24 and platform 26 is shaped such that foot end 41 (FIG. 1) of infant seat 22 (FIG. 1) is oriented proximate fixed-length stabilizer 86. Consequently, length-adjustable stabilizer 88, positioned in the opposite corner of base 24 from fixed-length stabilizer enables head end 43 (FIG. 1) of infant seat 22 to be oriented proximate length-adjustable stabilizer 88.

Second end 106 of fixed-length stabilizer 86 includes a universal joint 164 that pivotally couples mounting plate 90 to fixed-length stabilizer 86. Fourth end 110 of length-adjustable stabilizer 88 also includes a universal joint 166 that pivotally couples mounting plate 90 to length-adjustable stabilizer 88. However, although fixed-length stabilizer 86 non-pivotally couples to base 24, length-adjustable stabilizer 88 pivotally couples to base 24 via a pivot joint 168. Pivot joint 168 limits rotation of length-adjustable stabilizer 88 in a direction 170 that longitudinally bisects (i.e., moves toward and away from) fixed-length stabilizer 86.

In general operation, an infant is properly strapped into infant seat 22 (FIG. 1). Infant seat 22 is locked into platform 26 utilizing fastener system 34 (FIG. 1). At user module 28 (FIG. 1), power switch 52 (FIG. 1) is actuated to turn power “on” to motion simulator system 20 (FIG. 1). A mode is selected, such as highway, off-road, city, winding, or random mode utilizing mode control 54 (FIG. 1). Intensity level is selected from 1-5, with “1” being the most subtle level utilizing level control 56 (FIG. 1). An internal timer (not shown) can limit run-time. Alternatively, a run-time can be selected utilizing timer control 58 (FIG. 1). Logic controller 114 (FIG. 3) controls first and second actuators 74 and 76 (FIG. 2), respectively, to enable motion of platform 26 relative to base 24.

The combination of translational movement 146 of first actuator 74 and translational movement 162 of second actuator, as well as the pivoting activity at first upper and lower pivot points 138 and 142, respectively, and the pivoting activity at second upper and lower pivot points 154 and 158, respectively, enable smooth movement of platform 26 relative to base 24 about transverse axis 68, longitudinal axis 70, and in heave 66. In particular, fixed-length stabilizer 86 forms the primary location about which platform 26 pivots in pitch 62 and roll 64. Length-adjustable stabilizer 88 adjusts vertically to accommodate heave 66 of the three degrees-of-freedom motion of platform 26 relative to base 24. The location of length-adjustable stabilizer 88 proximate head end 43 (FIG. 1) yields the greatest perception of heave 66 for the infant in infant seat 22 (FIG. 1). Similarly, the location of fixed-length stabilizer 86 at foot end 41 (FIG. 1) yields the greatest perception of pitch 62 and roll 64 for the infant.

Motion simulator system 20 is described for providing a motion-based calming technique to an infant in an infant seat. However, motion simulator system 20 may be scaled for weight increases and adult sizes and the platform design may be modified so that system 20 can be utilized for medical physical therapy. For example, system 20 may be shortened, heavy duty motors might replace motor system 78 (FIG. 2), and platform 26 may be flat on top to accommodate a wheelchair or a standing patient. Similar programs for motion and intensity can be controlled by either a therapist or the patient.

In summary, the present invention teaches of a motion simulator system having a three degrees-of-freedom motion that simulates the motion of a vehicle. The motion simulator system includes a platform that is shaped to cradle an infant seat and a fastener system for attachment of the infant seat to the platform. The motion simulator system utilizes a translation-to-rotation system for enabling rotation of the platform about a transverse axis, a longitudinal axis, and translation of the platform in heave. The translation-to-rotation system of a motor, rotation part, non-extendible actuator, and interconnecting pivot points yields a motion simulator system that can be cost effectively produced and maintained and is durable. Pre-programmed, selectable motion profiles allow for a variety of modes and intensities of movement so that an optimal motion profile can be selected to calm a crying infant. Moreover, the variation of modes and intensities of movement reduces the undesired effect of motion anticipation found in repetitive motion systems.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A motion simulator system comprising:
a base;
a platform;
a first actuator having a first upper end coupled to said platform at a first upper pivot point rotatable relative to a first principal axis and a first lower end in communication with said base via a first lower pivot point rotatable relative to a second principal axis that is orthogonal to said first principal axis;
a second actuator having a second upper end coupled to said platform at a second upper pivot point rotatable relative to said second principal axis and a second lower end in communication with said base via a second lower pivot point rotatable relative to said first principal axis; and
a controller in communication with each of said first and second actuators for imparting translational movement to said first and second movable actuators, said translational movement enabling motion of said platform relative to said base about said first principal axis, about said second principal axis, and in heave.

2. A motion simulator system as claimed in claim 1 wherein each of said first and second actuators is a non-extendible rod element.

3. A motion simulator system as claimed in claim 1 wherein:
said first principal axis is a transverse axis;
said second principal axis is a longitudinal axis;
said first upper pivot point and said second lower pivot point enable rotation about said transverse axis; and
said first lower pivot point and said second upper pivot point enable rotation about said longitudinal axis.

4. A motion simulator system as claimed in claim 1 further comprising:
a motor system within said base;
a first rotation part rotatable about a first axis of rotation by said motor system, said first actuator being coupled to said first rotation part via said first lower pivot point at a first position located a radial distance away from said first axis of rotation; and
a second rotation part rotatable about a second axis of rotation by said motor system, said second actuator being coupled to said second rotation part via said second lower pivot point at a second position located said radial distance away from said second axis of rotation.

5. A motion simulator system as claimed in claim 4 wherein said first axis of rotation is oriented substantially orthogonal to said second axis of rotation.

6. A motion simulator system as claimed in claim 4 wherein:
said first rotation part rotates about said first axis of rotation substantially parallel to said second principal axis; and
said second rotation part rotates about said second axis of rotation substantially parallel to said first principal axis.

7. A motion simulator system as claimed in claim 1 further comprising a fixed-length stabilizer having a first end non-pivotally coupled with one of said base and said platform and having a second end pivotally coupled with the other of said base and said platform.

8. A motion simulator system as claimed in claim 7 further comprising a length-adjustable stabilizer having a third end pivotally coupled with said base at a location within said base opposing said fixed-length stabilizer and having a fourth end pivotally coupled with said platform.

9. A motion simulator system as claimed in claim 8 wherein said location of said length-adjustable stabilizer diagonally opposes said fixed-length stabilizer within said base.

10. A motion simulator system as claimed in claim 8 wherein said third end of said length-adjustable stabilizer includes a pivot joint that limits rotation of said length-adjustable stabilizer to a plane that longitudinally bisects said fixed-length stabilizer.

11. A motion simulator system as claimed in claim 8 wherein said platform is configured to support an infant seat such that a foot end of said infant seat is oriented proximate said fixed-length stabilizer and a head end of said infant seat is oriented proximate said length-adjustable stabilizer.

12. A motion simulator system as claimed in claim 1 wherein said platform is adapted for attachment of an infant seat.

13. A motion simulator system as claimed in claim 12 wherein said platform comprises a fastener system for attachment of said infant seat to said platform.

14. A motion simulator system as claimed in claim 1 further comprising:
means, coupled to said platform, for detecting said motion of said platform relative to said base; and
means for communicating said detected motion of said platform to said controller.

15. A motion simulator system as claimed in claim 1 wherein said controller is located within said base, and said system further comprises:
a user module positioned remote from said base and said platform; and
transfer means in communication with said controller for enabling regulation of said controller by a user.

16. A motion simulator system as claimed in claim 15 further comprising a memory in communication with said controller and having stored therein a plurality of motion profiles selectable at said user module, each of said motion profiles simulating vehicular movement, and said transfer means transfers a control signal indicating one of said motion profiles selected by said user.

17. A motion simulator system comprising:
a base;
a platform;
a non-extendible actuator having an upper end coupled to said platform at an upper pivot point rotatable relative to a first principal axis and a lower end having a lower pivot point rotatable relative to a second principal axis;
a motor system within said base;
a rotation part rotatable about an axis of rotation by said motor system, said actuator being coupled to said rotation part via said lower pivot point at a position located a radial distance away from said axis of rotation;
a controller in communication with said motor system for directing rotation of said rotation part to impart translational movement to said movable actuator, said translational movement enabling motion of said platform relative to said base.

18. A motion simulator as claimed in claim 17 further comprising:
a second non-extendible actuator having a second upper end coupled to said platform at a second upper pivot point rotatable relative to said second principal axis and a second lower having a second lower pivot point rotatable relative to said first principal axis; and
a second rotation part rotatable about a second axis of rotation by said motor system, said second actuator being coupled to said second rotation part via said second lower pivot point at a second position located said radial distance away from said second axis of rotation, and said motor system imparting said translational movement to said second actuator, wherein said translational movement of each of said actuator and said second actuator enables motion of said platform about said first principal axis, about said principal axis, and in heave.

19. A motion simulator system as claimed in claim 17 further comprising a fixed-length stabilizer having a first end non-pivotally coupled with one of said base platform and having a second end pivotally coupled with the other of said base and said platform.

20. A motion simulator system as claimed in claim 19 wherein said platform is configured to support an infant seat such that a foot end of said infant seat is oriented proximate said fixed-length stabilizer.

21. A motion simulator system comprising:
a base;
a platform;
a first actuator having a first upper end coupled to said platform at a first upper pivot point rotatable relative to a first principal axis and a first lower end in communication with said base via a first lower pivot point rotatable relative to a second principal axis;
a second actuator having a second upper end coupled to said platform at a second upper pivot point rotatable relative to said second principal axis and a second lower end in communication with said base via a second lower pivot point rotatable relative to said first principal axis;
a fixed-length stabilizer having a first end non-pivotally coupled with one of said base and said platform and having a second end pivotally coupled with the other of base and said platform;
a controller located within said base and in communication with each of said first and second actuators for imparting translational movement to said first and second movable actuators, said translational movement enabling motion of said platform relative to said base about said first principal axis, about said second principal axis, and in heave; and
a user module positioned remote from said base and said platform and in communication with said controller for enabling regulation of said controller by a user.

22. A motion simulator system as claimed in claim 21 wherein:
said first principal axis is a transverse axis;
said second principal axis is a longitudinal axis;
said first upper pivot point and said second lower pivot point enable rotation about said transverse axis; and
said first lower pivot point and said second upper pivot point enable rotation about said longitudinal axis.

23. A motion simulator system as claimed in claim 21 a length-adjustable stabilizer having a third end pivotally coupled with said base at a location within said base diagonally opposing said fixed-length stabilizer and having a fourth end pivotally coupled with said platform.
